(19) United States
(12) Patent Application Publication
(10) Pub. No.: US 2022/0033984 A1
(43) Pub. Date: Feb. 3, 2022

(54) MODULAR SYSTEM FOR HYDROGEN AND AMMONIA GENERATION WITHOUT DIRECT WATER INPUT FROM CENTRAL SOURCE

(71) Applicant: OHMIUM INTERNATIONAL, INC., Incline Village, NV (US)

(72) Inventors: Peter LIGHT, San Francisco, CA (US); Kirsten BURPEE, San Jose, CA (US); Arne BALLANTINE, Incline Village, NV (US); Zachary BURPEE, San Jose, CA (US)

(21) Appl. No.: 17/387,170

(22) Filed: Jul. 28, 2021

Related U.S. Application Data
(60) Provisional application No. 63/057,406, filed on Jul. 28, 2020.

(51) Int. Cl. C25B 15/08; C25B 1/04; C25B 1/27; C25B 9/19; B01D 53/26; B01D 53/28; B01D 53/04; B01D 5/00

(52) U.S. Cl. CPC C25B 15/08; C25B 1/04; C25B 1/27; C25B 9/19; B01D 53/261; B01D 2253/204; B01D 53/0454; B01D 53/0438; B01D 5/0072; B01D 5/009; B01D 53/28

(57) ABSTRACT

A method of generating oxygen and at least one of hydrogen or ammonia includes receiving ambient air containing moisture, collecting liquid water from the ambient air, receiving, by a water electrolyzer, the collected liquid water and electricity from an electrical source, and performing an electrolysis process by the water electrolyzer to thereby generate the oxygen and the at least one of hydrogen or ammonia from the received liquid water and electricity.

### CROSS-REFERENCE TO RELATED APPLICATION

This application claims the benefit of U.S. Provisional Patent Application No. 63/057,406, filed on Jul. 28, 2020, the entire contents of which are incorporated herein by reference.

### FIELD

This disclosure is directed to chemical production in general and, more specifically, to systems and methods of hydrogen and ammonia synthesis.

### BACKGROUND

Hydrogen is a common gas that has many industrial uses, such as petroleum refining, metal treatment, food processing, semiconductor fabrication, and ammonia production. Although hydrogen is abundant and can be formed from a variety of renewable and non-renewable energy sources, the combustibility of hydrogen in air makes hydrogen difficult to store and ship. As a result, hydrogen is generally not amenable to large-scale production at a centralized facility for subsequent distribution across large geographical regions. Rather, hydrogen is generally used at or near the site of its production.

Ammonia is common inorganic chemical having a variety of uses, such as fertilizer production, pharmaceutical manufacturing, and cleaning. Although ammonia is naturally occurring, the demand for ammonia for these and other uses far exceeds the amount of ammonia that can be efficiently and responsibly collected from sources in nature. Thus, industrial-scale processes are typically used to synthesize ammonia from nitrogen and hydrogen. The economic viability of ammonia synthesis, however, depends on achieving high yield. In turn, the high temperatures and pressures required to achieve such high yield in ammonia synthesis present logistical challenges, in terms of resources and safety, that limit where ammonia can be synthesized.

Accordingly, there remains a need for hydrogen and ammonia synthesis that can be carried out cost-effectively using reactors that are amenable to safe implementation in a wide range of locations, including resource-constrained areas.

### SUMMARY

One embodiment provides a system configured to generate oxygen and at least one of hydrogen or ammonia, comprising a water generation device that is configured to collect liquid water from ambient air that contains moisture, and a water electrolyzer that is configured to receive the liquid water collected by the water generation device, to receive electricity from an electrical source, and to perform an electrolysis process to thereby generate the oxygen and the at least one of hydrogen or ammonia from the received liquid water and electricity.

Another embodiment provides a method of generating oxygen and at least one of hydrogen or ammonia includes receiving ambient air containing moisture, collecting liquid water from the ambient air, receiving, by a water electrolyzer, the collected liquid water and electricity from an electrical source, and performing an electrolysis process by the water electrolyzer to thereby generate the oxygen and the at least one of hydrogen or ammonia from the received liquid water and electricity.

### BRIEF DESCRIPTION OF THE DRAWINGS

Aspects of this disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a block diagram of a system that is configured to generate oxygen, and at least one of hydrogen or ammonia, according to various embodiments.

FIG. 2 is a block diagram of a further system that is configured to generate oxygen, and at least one of hydrogen or ammonia, according to various embodiments.

FIG. 3 is a block diagram of a further system that is configured to generate oxygen, and at least one of hydrogen or ammonia, according to various embodiments.

FIG. 4 is a block diagram of a further system that is configured to generate oxygen, and at least one of hydrogen or ammonia, according to various embodiments.

FIG. 5 is a flowchart illustrating various operations of a method of generating oxygen, and at least one of hydrogen or ammonia, according to various embodiments.

Like reference symbols in the various drawings indicate like elements.

### DETAILED DESCRIPTION

The disclosed embodiments are described more fully hereinafter with reference to the accompanying figures, in which exemplary embodiments are shown. The foregoing may, however, be embodied in many different forms and should not be construed as being limited to the exemplary embodiments set forth herein. All fluid flows may flow through conduits (e.g., pipes and/or manifolds) unless specified otherwise.

All documents mentioned herein are hereby incorporated by reference in their entirety. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or,” and the term “and” should generally be understood to mean “and/or.”

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately,” or the like, when accompanying a numerical value, are to be construed as including any deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples or exemplary language (“e.g.,” “such as,” or the like) is intended merely to better illuminate the embodiments and does not pose a limitation on the scope of those embodiments. No language in the specification should be construed as indicating any unclaimed element as essential to the practice of the disclosed embodiments.

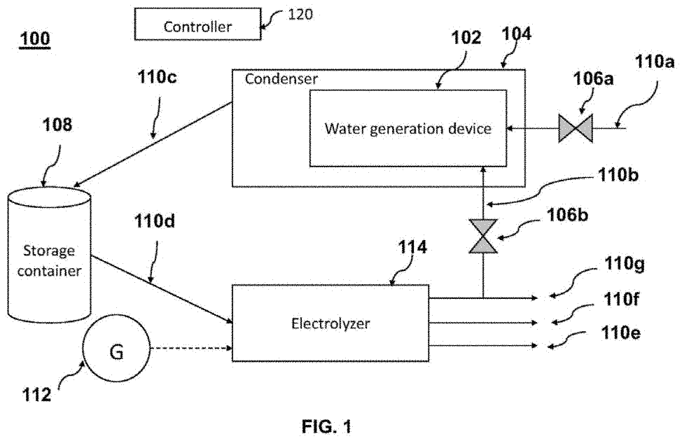

FIG. 1 is a block diagram of a system 100 that is configured to generate oxygen, and at least one of hydrogen or ammonia, according to various embodiments. The system may include a water generation device 102 that is configured to receive ambient air that contains moisture and to generate liquid water from the ambient air. The ambient air may be received through a first conduit 110a that may include a first valve 106a. The water generation device 102 may include a material that adsorbs moisture from the received ambient air in response to heat that is received by the water generation device 102 from a heat source, such as the Sun or another heat source, as described in greater detail below. For example a heated fluid may optionally be provided to the water generation device 102 through a second conduit 110b that may include a second valve 106b. The water generation device 102 generates heated humid air from the adsorbed moisture from the ambient air. The system may include a condenser device 104 that receives the heated humid air from the water generation device 102 and condenses the moisture in the heated humid air to form liquid water. The condenser device 104 condenses the moisture in the heated humid air to form liquid water by cooling the humid air. As such, the condenser device 104 may further include an active or passive cooler, as described in greater detail below. The liquid water may be provided from the condenser device 104 to a storage container 108 (e.g., water tank) through a third conduit 110c. The condensed water may be stored in the container 108 where the water may be treated and kept out of reach to prevent unwanted access or use.

The system may further include a water electrolyzer 114 that is configured to receive the water generated by the water generation device 102 and condenser device 104, to receive electricity from an electrical source (i.e., a power source) 112, and to perform an electrolysis process to thereby generate oxygen, and at least one of hydrogen or ammonia based on the received water and electricity. To generate ammonia, the hydrogen output of the electrolyzer 114 may be connected to an ammonia reactor where hydrogen is reacted with nitrogen to form ammonia, as described in U.S. Patent Application Publication US 2021/0155491 A1, filed on Nov. 23, 2020 and incorporated herein by reference in its entirety. The nitrogen may be provided from the ambient air using an oxygen-nitrogen separator, such as a refrigeration unit, a pressure swing adsorption system and/or a temperature swing adsorption system. If a refrigeration unit is used, then it may also be used to provide the cooling to condense liquid water from air, which will be described in more detail below. As shown in FIG. 1, the water electrolyzer 114 may receive the water from the storage container 108 through a fourth conduit 110d. In other embodiments (not shown), the water electrolyzer 114 may receive the water generated by the water generation device 102 and condenser device 104 directly from the water generation device 102 and condenser device 104. Any unused water from the electrolyzer 114 may be input back into the water container 108. Further embodiments may include a sensor (not shown) that measures the amount of water left in the container 108, and a paired system that determines if levels require the use of directly connected water from external sources (e.g., municipal or city water). Alternative external water sources may include sea water, dirty water that is scrubbed/filtered, rainwater, as described in greater detail below, etc. Various other water sources may be used. For example, water generated by an air conditioning unit or de-humidifier may be filtered and scrubbed for particulates and may then serve as a water source.

The hydrogen and/or ammonia generated by the water electrolyzer 114 may be provided as output from the water electrolyzer 114 through a fifth conduit 110e. Similarly, the oxygen generated by the water electrolyzer 114 by be provided as output from the water electrolyzer 114 through a sixth conduit 110f. The water electrolyzer 114 may generate heat by the electrolysis process. Such heat may be absorbed by a working fluid (e.g., heat transfer gas or liquid, such as water) that may circulate through the system. For example, a heated fluid may be provided as output from the water electrolyzer 114 through a seventh conduit 110g which is connected to the second conduit 110b. The system may include further conduits (not shown) that cause the fluid to circulate through the system to thereby continually remove heat generated by the water electrolyzer 114. As mentioned above, some of the heated fluid may be provided to the water generation device 102 through the second conduit 110b and the seventh conduit 110g to thereby provide heat to the water generation device 102. In other embodiments, the heat source may include a solar heat generation device (e.g., a solar mirror or solar absorber material, not shown) that is configured to generate heat based on received sunlight and to provide the generated heat to the water generation device 102. For example, sunlight exposed portions of water conduits (e.g., water pipes) may be coated with a solar heater (e.g., solar absorber material) which heats the input water based on received sunlight. Heat may also be generated by other components of the systems, such as by power electronics, etc. In this way, such other components may act as the heat source for the water generation device 102.

As mentioned above, the water generation device 102 may include a material that adsorbs moisture from ambient air that is received through the intake valve 106a via the first conduit 110a. In various embodiments, the material that adsorbs water from ambient air may include a metal-organic framework (MOF), which may be the same as or similar to metal-organic frameworks (e.g., MOF-801 or MOF-303) described in the article by Fathieh et al., published in Sci. Adv. 2018; 4: eaat 3192 (available at https://advances.sciencemag.org/content/advances/4/6/eaat3198.full.pdf), which is incorporated herein by reference in its entirety. Such integrated water generation device 102 and condenser device 104 water harvesting cycles starts with water saturation of unsaturated MOF upon exposure to ambient air at nighttime when the temperature is relatively cooler. This is followed by the release of captured water from the saturated MOF in the form of released water vapor upon the increase in temperature due to the exposure of the device to sunlight during daytime. The collecting cycle also takes place during daytime when the temperature is relatively hotter. The released water vapor humidifies the ambient, relatively hot air in the vicinity of the MOF. The hot humid air flows from the MOF into the condenser and is subsequently cooled down, for example by ambient cooling, to its dew point. This results in liquefied (i.e., liquid) water collected in the condenser. The collecting cycle (release-condensation) continues until the end of the daytime when the liquid water is collected and the next water harvesting cycle begins.

The electrical source 112 may comprise any power source, such as any electrical power generation and/or storage device. Examples of electrical sources include the power grid, battery, supercapacitor, wind turbine, hydroelectric power generation device or solar energy conversion device (e.g., photovoltaic cells or panels). For example, the solar energy conversion device electrical source 112 for the water electrolyzer 114 generates electricity from sunlight, and provides the electricity to the water electrolyzer 114, which electrolyzes water into oxygen and hydrogen. In various embodiments, the water electrolyzer 114 may include a polymer exchange membrane (PEM) type electrolyzer.

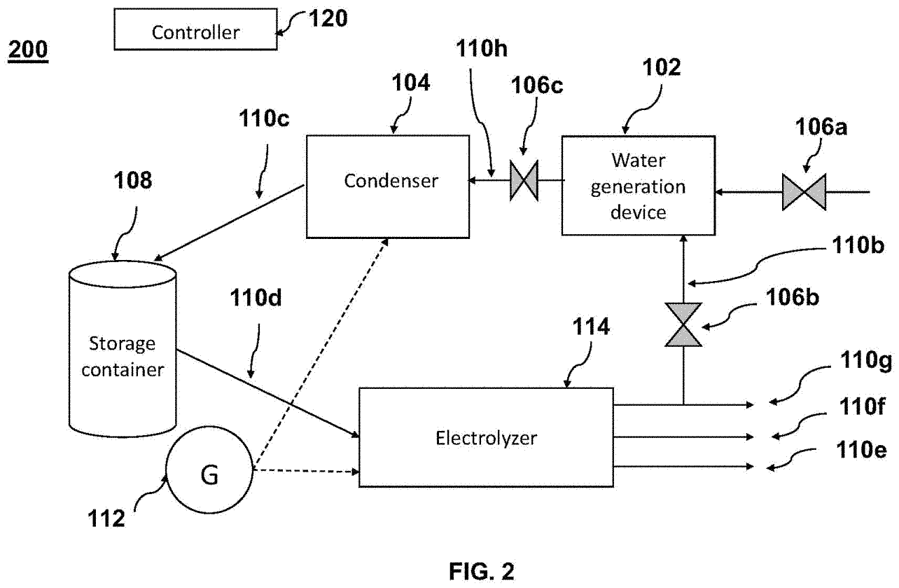

FIG. 2 is a block diagram of a system 200 that is configured to generate oxygen, and at least one of hydrogen or ammonia, according to various embodiments. The system 200 includes components similar to those of the system 100 of FIG. 1. In system 200, however, the condenser device 104 is provided as an external device. The condenser device 104 is configured to receive heated humid air from the water generation device 102 via an eighth conduit 110h. The eighth conduit 110h may further include a third valve 106c.

As mentioned above, the condenser device 104 may further include an active or passive cooling device that is configured to cool the humid air received from the water generation device 102 to thereby generate liquid water. In this example, the condenser device 104 may include an electrically powered cooling device (not shown). For example, the electrically powered cooling device may be a refrigeration device that uses a working fluid to remove heat from the humid air received by the condenser device 104. Alternatively, the cooling device may be a thermoelectric device or other cooling device that does not require a working fluid. The electrically powered cooling device may be configured to receive electrical power from an electrical source 112b. For example, the electrical source 112 may be a solar energy conversion device (e.g., photovoltaic device, which is also known as a solar cell) that is configured to act as the electrical source for both the water electrolyzer 114 and for the condenser device 104 (if the condenser device is an electrically operated condenser rather than an ambient air cooled condenser).

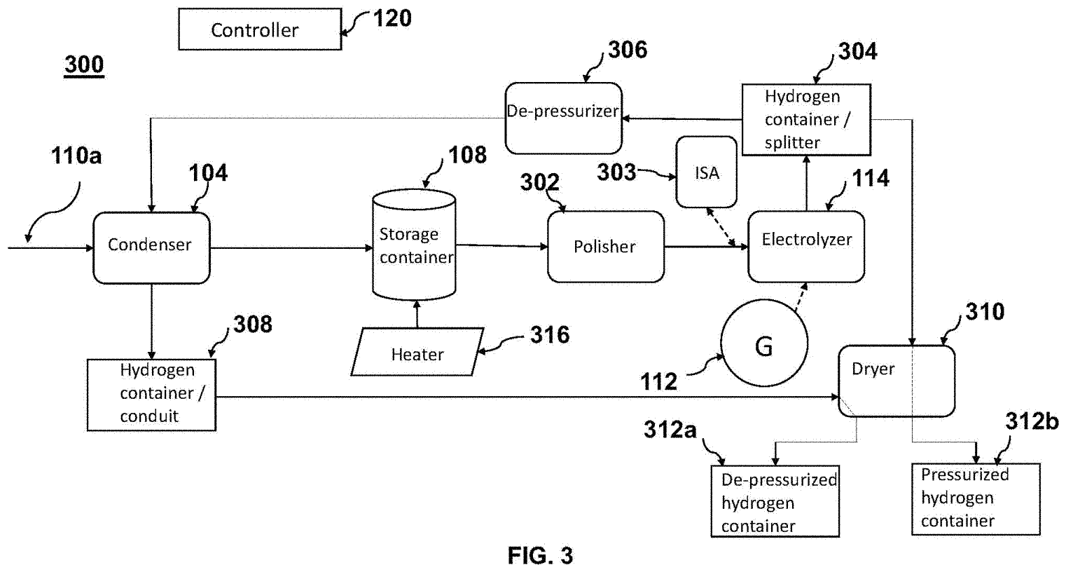

FIG. 3 is a block diagram of a system 300 that is configured to generate oxygen, and at least one of hydrogen or ammonia, according to various embodiments. While the systems 100 and 200, described above with reference to FIGS. 1 and 2, respectively, may be suitable for low relative humidity environments (e.g., humidity in a range from approximately 5% to 40%), the system 300 may be more suitable for environments having higher humidity (e.g., relative humidity in a range from approximately 35% to approximately 90%, such as about 70% at an average temperature of 85° F.). In this regard, the system 300 does not require, and therefore does not include, a water generation device 102 (e.g., see FIGS. 1 and 2) having a material (e.g., a metal-organic framework) that adsorbs and concentrates moisture to generate heated humid air. Rather, system 300 includes a condenser device 104 that is configured to directly receive humid ambient air and to cool the humid ambient air to thereby condense moisture to generate liquid water. Thus, the condenser device 104 acts as the water generation device that is configured to generate liquid water from humid ambient air.

As in other embodiments, the condenser device 104 may include an active or passive cooler. For example, the condenser device may include an active electrically powered cooler (not shown) that may be a refrigeration device that uses a working fluid. Alternatively, the cooling device may be a thermoelectric or other device that does not require a working fluid. In still further embodiments, as described in detail below with reference to FIG. 3, the condenser device 104 may be a passively cooled device that receives cooled gas (e.g., cool ambient air, hydrogen output by the electrolyzer 114 or another heat transfer working gas) from other parts of the system 300 and cools the humid ambient air by allowing the cooled gas to absorb heat from the humid ambient air.

The condenser device 104 of system 300 is configured to receive humid ambient air through a first conduit 110a. For simplicity of description, other conduits in system 300 are not specifically labeled or described. The condenser device 104 cools the humid ambient air to thereby generate liquid water. The liquid water may then be provided to a storage container 108, as described above with reference to systems the 100 and 200 of FIGS. 1 and 2, respectively. The system 300 may further include a water polisher 302 that is configured to filter and clean the water generated by the condenser device 104. The system 300 may further include a water electrolyzer 114 that is configured to receive water from the water polisher 306, to receive electricity from the electrical source 112 described above, and to perform an electrolysis process to thereby generate oxygen, and at least one of hydrogen or ammonia based on the received water and electricity. In further embodiments, an impedance spectroscopy analyzer (ISA) device 303 may be used to characterize water processed by the water polisher 302 to thereby monitor a status and life of the polisher 302 (e.g., whether the filter in the polisher 302 is clogged or reached the end of its useful life). For example, the impedance spectroscopy analyzer device 303 may be positioned downstream of the polisher and upstream of the electrolyzer (e.g., on the water conduit connecting the polisher and the electrolyzer, right before the water inlet to the electrolyzer) to electrochemically analyze the water being provided from the polisher 302 into the electrolyzer 114. The device 303 may detect if the water being provided from the polisher 302 into the electrolyzer 114 is charged or carries dirty particulates (e.g., impurities), and then raise an alarm that the polisher 302 filter should be replaced if charge or particulates are detected.

One of the output products of the electrolysis process performed by the water electrolyzer 114 is heated pressurized hydrogen gas. The system 300 may further include a container or splitter 304 that is configured to capture the heated pressurized hydrogen gas generated by the water electrolyzer 114. The system 300 may further include a de-pressurizer device 306 that is configured to receive a portion of the pressurized hydrogen gas from the container or splitter 304. The de-pressurizer device 306 may comprise an expander cone or another suitable device which expands the volume of container through which the gas flows. The de-pressurizer device 306 may be configured to reduce the pressure of the hydrogen gas to thereby generate cooled de-pressurized hydrogen gas. The hydrogen gas becomes cooled as it is de-pressurized due to the Joule-Thomson effect. The cooled de-pressurized hydrogen gas may then be provided to the condenser device 104. In other embodiments, external coolant or gas canisters (e.g., carbon dioxide or nitrogen) may be used as a substitute for the hydrogen gas. For example, circulating nitrogen gas in the electrolyzer 114 stack (which may be used for fire suppression) may be used in place of the hydrogen. In other embodiments, a commercial atmospheric water condenser may be used.

The condenser device 104 may be configured to allow the cooled de-pressurized hydrogen gas received from the de-pressurizer device 306 to remove heat from the ambient humid air within the condenser device 104. In this regard, the condenser device 104 may include an open enclosure that is configured to allow the humid ambient air to flow through the enclosure. The condenser device 104 may further include a tube or manifold (not shown) positioned within the open enclosure that is configured to allow the cooled gas, such as the cooled hydrogen gas to flow through the tube or manifold such that heat from the humid ambient air becomes absorbed through walls of the tube or manifold due to a temperature difference between the humid ambient air within the enclosure, external to the tube or manifold, and the cooled hydrogen gas within the tube or manifold, thereby cooling the humid ambient air. In an example embodiment, the tube or manifold may comprise a coil having a plurality of loops. The coil may be constructed of a material that has a relatively high thermal conductivity, such as copper or other metallic material. The inclusion of multiple loops in the coil increases the effective surface area over which the humid ambient air may transfer heat to the cooled de-pressurized hydrogen gas within the tube.

The system 300 may further include a container or conduit 308 that is configured to receive the depressurized hydrogen gas from the condenser device 104 after the depressurized hydrogen gas has circulated through the condenser device 104. In general, the depressurized hydrogen gas received by the container or conduit 308 may include water vapor (i.e., damp hydrogen). The system 300 may further include a dryer device 310 that may be configured to receive the depressurized hydrogen gas from the container or conduit 308 and to remove water vapor from the depressurized hydrogen gas to thereby generate dried depressurized hydrogen gas. The dryer device 310 may comprise water vapor separator membrane or a dehumidifier device. The system 300 may further include a container 312a that may be configured to receive the dried depressurized hydrogen gas and to store the dried depressurized hydrogen gas until it is needed for various applications (e.g., used as fuel, sold to a customer, etc.).

It may be advantageous in various other applications, to generate pressured hydrogen gas. As such, the dryer device 310 may receive another portion of the pressurized hydrogen gas from the hydrogen splitter 304. In general, the depressurized hydrogen gas received by the splitter 304 may include water vapor. As such, the dryer device 310 may remove water vapor from the pressurized hydrogen gas to thereby generate dried pressurized hydrogen gas. The system 300 may further include a container 312b that may be configured to receive the dried pressurized hydrogen gas and to store the dried pressurized hydrogen gas until it is needed for various applications (e.g., used as fuel, sold to a customer, etc.).

The system 300 may further include a heater device 316 that may be configured to heat the water generated by the condenser device 104 after the water is received from the condenser device 104. For example, during a startup operation of the system 300 it may be advantageous to provide heated water to the water electrolyzer 114. The heater device 316 may include various heating mechanisms. For example, the heater device 116 may include an electrical heating device (e.g., a resistive heater) or a solar heating device (e.g., solar absorber material) that may be configured to provide heat to the water in the storage container 108

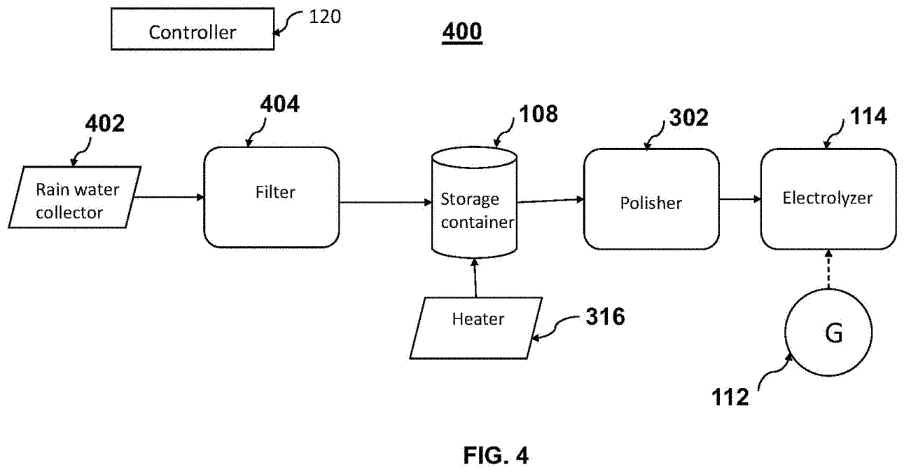

FIG. 4 is a block diagram of a system 400 that is configured to generate oxygen, and at least one of hydrogen or ammonia, according to various embodiments. In contrast to systems 100, 200, and 300, of FIGS. 1, 2, and 3, respectively, which generate liquid water from humid air, the system 400 contains a rain water collector 402 as the water generation device that is configured to generate liquid water (i.e., rain water) from ambient air. For example, system 400 may be configured to collect rain water from a rain water collector (e.g., an open rain water storage container, a gutter, etc.) 402. The system may include a water filter 404 (e.g., a gravity filter) that is configured to receive rain water from the rain water collector 402 and to filter the received rain water. For example, the rain water collector 402 may comprise one or more gutter pipes which may funnel the collected rain water to the gravity filter 404. Rain water may be collected from building roofs or other covered or uncovered areas where the system may be located. The system 400 may further include a container 108 that may be configured to receive and store the filtered rain water.

The system 400 may further include the above described water polisher 306 that may be configured to receive the filtered rain water from the container 108 and to further clean and purify the filtered rain water. The system 400 may further include the above described water electrolyzer 114. As with other embodiments, the water electrolyzer 114 may be configured to receive the purified rain water from the water polisher 306, to receive electricity from the electrical source 112, and to perform an electrolysis process to thereby generate oxygen, and at least one of hydrogen or ammonia from the rain water received from the water polisher 306. The system 400 may also include the heater 316 and/or various other system components that may be coupled to the water electrolyzer 114, as described in greater detail with reference to FIGS. 1 to 3, above.

The various embodiments described above may further include a processor-implemented system controller 120 and various sensors. For example, systems 100 to 400, described above with reference to FIGS. 1 to 4, respectively, may include an ISA device 303, which may be configured to measure an impedance of the water provided from the condenser device 104 (e.g., see FIG. 3). Furthermore, a water conductivity sensor (i.e., conductivity meter) may be installed downstream of the water generation device 102 and the condenser device 104. The processor-implemented controller 120 may be configured to receive the measured water conductivity and to determine a state of health or degradation of the water generation device 102 based on the measured conductivity. For example, the water generation device 102 of systems 100 and 200 includes a metal-organic framework that is prone to degradation over time. As the metal-organic framework degrades it may shed metal ions which may become suspended in the water generated by the water generation device 102 and condenser device 104. The presence of such metal ions in the water may be detected by measuring their effect on the conductivity of the water (i.e., the conductivity of water increases with increased metal ion concentration in the water). As such, the impedance of the water may be used as an indicator of the state of heath or degradation of the water generation device.

The various embodiments described above may further include a water production sensor configured to measure an amount of water generated by the water generation device 102. The processor-implemented controller, described above, may be further configured to determine a predicted amount of generated water, and to determine a state of health or degradation of the metal-organic framework based on a comparison of the measured amount of water and the predicted amount of generated water. In this regard, the amount of water generated by the metal-organic framework may decrease over time as the metal-organic framework degrades. Thus, the determination of the state of health or degradation may be based on an understanding of the correlation between degradation and water production. Such a correlation may be determined empirically based on experiments and/or may be based on a theoretical model.

The various embodiments described above may further include a temperature sensor configured to measure a temperature of the ambient air, and a humidity sensor configured to measure a humidity of the ambient air. The processor-implemented controller, described above, may be further configured to determine the predicted amount of generated water based on the measured temperature and humidity of the ambient air. The predicted amount of generated water may be based on an understanding of the correlation between temperature and humidity of the ambient air and an amount of water that may be generated. Such a correlation may be determined empirically based on experiments and/or may be based on a theoretical model. In other embodiments, the controller may determine a desired hydrogen output for a location of interest and may determine an amount of collection area available and average annual rainfall. The system may further track a total amount of water input into the system and may compare the determined total input amount of water to a predetermined environment based annual rainfall amount.

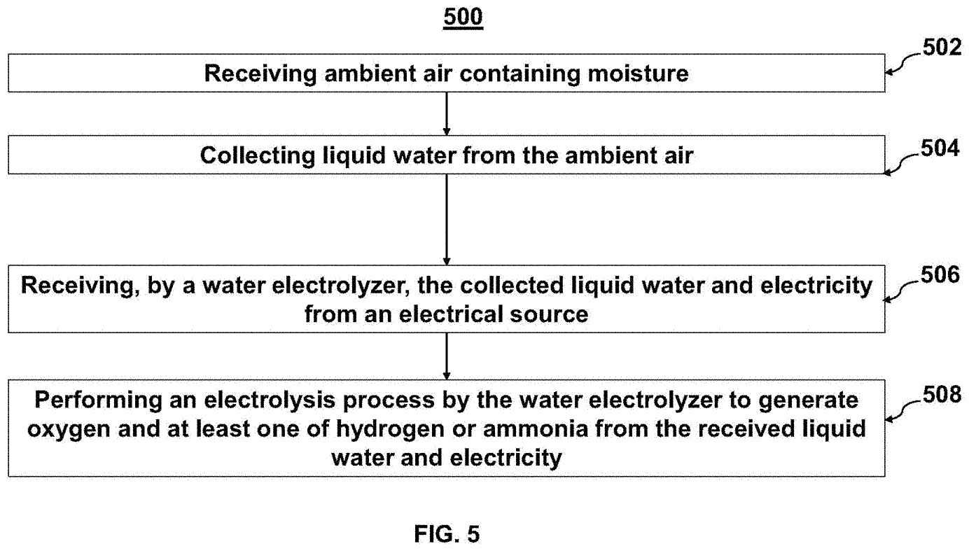

FIG. 5 is a flowchart illustrating various steps of a method 500 of generating oxygen and at least one of hydrogen or ammonia, according to various embodiments. In step 502, the method 500 may include receiving ambient air containing moisture. In step 504, the method 500 may include collecting generating liquid water from the ambient air. For example, the liquid water may be collected using at least one of the water generation device 102 and/or the condenser device 104 that generates the liquid water from the moisture in the ambient air, or by the rain water collector 402 which collects rain water from the ambient air. In step 506, the method 500 may include receiving, by a water electrolyzer 114, the collected liquid water and electricity from an electrical source 112. In step 508, the method 500 may include performing an electrolysis process by the water electrolyzer 114 to thereby generate oxygen and at least one of hydrogen or ammonia from the received liquid water and electricity.

In one embodiment, step 504 of the method 500 may include collecting the liquid water using the water generation device 102 that includes a metal-organic framework. The method 500 may further include receiving the electricity from a solar energy conversion device (e.g., photovoltaic device), which is configured to generate the electricity from received sunlight. The method 500 may further include using a water generation device 102 that includes a cooler to collect the liquid water. In this regard, the cooler may be used to cool and condense the ambient air to thereby generate the liquid water. In various embodiments, the cooler may be an electrically powered cooler that includes a working fluid, such as de-pressurized hydrogen output from the electrolyzer 114. In other embodiments, the cooler may be a thermoelectric cooler that does not require a working fluid.

In further embodiments, the cooler may be configured to received cooled gases from other parts of the system. Thus, the method 500 may further include, for example, receiving cooled hydrogen gas generated by the water electrolyzer 114 and using the cooled hydrogen gas to remove heat from the ambient air to thereby cool the ambient air. As described above, the hydrogen gas may be generated by the electrolyzer 114 in a pressurized state and a de-pressurizer device 306 may be used to reduce the pressure of the hydrogen gas to thereby generate cooled de-pressurized hydrogen gas. The hydrogen gas becomes cooled as it is de-pressurized due to the Joule-Thomson effect. The cooled de-pressurized hydrogen gas may then be provided to a condenser device 104, which acts as the cooler to cool the ambient air.

The method 500 may further include measuring, using a water production sensor, an amount of water generated by the water generation device; measuring, using a temperature sensor, a temperature of the ambient air; and measuring, using a humidity sensor, a humidity of the ambient air. The method 500 may further include determining, using the processor-implemented controller (described above), a predicted amount of generated water based on the measured temperature and humidity of the ambient air. The method 500 may further include determining, by the controller, a state of health or degradation of the system based on a comparison of the measured amount of generated water and the predicted amount of generated water.

Further embodiments may include a modular oxygen delivery and storage system that provides compressed and dry oxygen to the electrolyzer 114, eliminating a need for a pure-oxygen rating of the electrolyzer 114. The system may include compression and drying systems. The system may include hardware which is pure-oxygen rated and thereby the balance of the system does not require a pure-oxygen rating. The system may be configured to run a pre-start-up sequence which may automatically check for leaks. The system may be configured to prevent initiation of the electrolyzer 114 when a leak is detected. The compression system used to compress dry oxygen may be an electrochemical and/or mechanical system. The controller may be configured to monitor a necessary load and to adjust the system accordingly. For example, the controller may be configured to optimize various control parameters to generate various outputs for various circumstances.

For example, the controller may optimize hydrogen storage for times when the electrical load on the electrical source 112 is low, and may optimize for day/night cycles and for solar and wind energy use. The system may include integrated on-site hydrogen storage and separate fire suppression systems. The system may include redundant power routing to avoid single points of failure. For example, the system may include a network of power supplies, electrolyzers, compressors, and gas storage systems. The system may be configured to react to regional catastrophes and power outages, which may thereby minimize a delay in re-energizing the grid which is used as the electrical source 112. For example, the system may include a rectifier coupled to the power grid that may be configured to supply electrical power to the grid from a DC bus fuel cell generator that includes ultracapacitors. A disruption in energy supply from the power grid may be compensated by supplying energy from the ultracapacitors while initiating power generation by the fuel cells. The system may include a telemetry integration system that may be configured to provide data to a data center.

The system may further be configured to produce a maximum output of hydrogen and oxygen, even if the demands for the respective gases are not in sync. In this regard, excess gas may be stored for use later or for use by another party. The electrolyzer 114 may be configured as a straight-piped system that includes sensors that test for hydrogen and oxygen leakage. The system may be configured to have one-way routing of hydrogen and oxygen gases to avoid fire risks to the electrolyzer 114. The system may include a chamber where the hydrogen and oxygen may be combusted and the constituents and products may be measured and compared against ideal stoichiometric values. Any measured differences in values may be an indicator of a leak. The system controller may be configured to control the system, based on weather and atmospheric data, to generate maximum amounts of hydrogen and ammonia from projected water produced by the water generation device and based on electricity supplied (e.g., from solar, wind, hydro, etc.).

The system may further include sensors coupled to the electrolyzer which may relay a “transmission of action” request to the controller if there is a fire detected inside the system. For example, the requested action may include flooding an enclosure with an inert gas such that the fire may be extinguished. The sensors may be configured to detect products of combustion, and the controller may initiate rapid release of the inert gas within the electrolyzer 114 in response to signals from the sensor. Such injection of the inert gas may evacuate an enclosure of the combustion constituents, to thereby ensure that any fire may be largely, if not completely, extinguished, and/or may be confined to a region above the electrolyzer hardware. Inert gas can may include be nitrogen or argon, for example.

In further embodiments, nitrogen-rich air (comprising greater than 80% by volume nitrogen) may be circulated throughout electrolyzer enclosures. Such nitrogen-rich air may be produced from an air-derived nitrogen plant as a slip-stream output or an air-derived oxygen plant which innately makes waste gas very nitrogen rich. Oxygen levels may be controlled to be below 16% in order to prevent fires. The system may include a source of compressed inert gas. The system may include plumbing from the electrolyzer 114 to vents into a cabinet/enclosure. Alternatively, the system may include plumbing form the electrolyzer 114 that vents into the anode or cathode of the electrolyzer 114. In light-intensive or hot environments, modular stacks of the electrolyzer 114 may be are covered with solar (i.e., photovoltaic) panels and/or reflective coatings to ensure that electronics and heat sensitive processes inside the electrolyzer 114 are protected. The presence of solar panels, of course, has the additional advantage of generating electricity from received solar energy.

The disclosed embodiments include various advantages. For example, disclosed systems generate hydrogen and/or ammonia from ambient air using renewable (e.g., solar) energy. Systems may include a separate oxygen dryer and compression system that eliminates a need for the system to be pure-oxygen rated. The system may optimize hydrogen storage with power delivery when under load. The system may further prevent fires in system enclosures. The system avoids a need for input water to the electrolyzer 114. The system may thus be used in environments in which water may not be accessible. The system avoids a need for input electricity from a stationary source to power necessary components for the electrolyzer. Further, external heat emission to the environment from the electrolyzer 114 may be minimized by recycling the heat generated by the electrolyzer 114 back into the water generation device 102.

The system may have a further advantage in that it may be effectively used as a de-humidifier for humid environments. The system may efficiently generate dry oxygen (using a separate compression and drying sub-system) to thereby conserve energy. The system may further be configured to synthesize various chemical compounds from combinations of H₂, N₂, and O₂. In embodiments having multiple water generation devices 102, the system controller may be configured to determine whether any of the generation devices 102 are malfunctioning or are degraded and therefore need to be replaced. The controller may further be configured to determine desired and actual amounts of water generated by the water generation device 102.

Disclosed embodiments eliminate the need for a pure-oxygen rating on the electrolyzer 114 (i.e., stack system). The system may further include a separate oxygen dryer and compressor system that is configured as a modular unit for easy accessibility, service, and installation. The system may be configured to automatically check for leaks during start-up, and a modular design allows electrolyzer 114 stack components to be added or subtracted, thereby making the system accessible and portable. The system may further include an air circulator for the water generation device 102. The air circulator may recycle heat such that the system requires less power to provide a required amount of heat to the water generation device 102.

Disclosed embodiments may minimize exhaust output and overproduction of hydrogen, which may otherwise lead to a safety hazard or risk of fire. The system may also respond faster to grid malfunctions and may keep electricity flowing during disruptions to the power grid. The system may be combined with different input and output systems to determine optimized hydrogen production and storage.

The controller may be configured to control the system to generate a quantity of water for the electrolysis process based on a forecast of hydrogen quantity required to be produced over an upcoming multi-day period. For example, the system may control an amount of heat and ambient air provided to the water generation device 102 based on a measured air humidity and forecasted required water.

In addition to generating ammonia, the electrolyzer 114 may be configured to generate NₓH_{y} molecules, such as ammonia. Further, oxygen generated by the electrolyzer 114 may be used to create NₓH_{y}O_{z} molecules. In further embodiments, the system may be placed near a refrigeration plant that uses nitrogen as a primary source of refrigeration. Nitrogen provided by the plant may be used to pump nitrogen through the system. Excess water generated by the system may also be fed into the electrolyzer 114 as needed to synthesize various compounds.

As described above, the system may be used as a de-humidifier in a greenhouse facility or other humid environment. As such, the system may extract extra water from the humid environment. In a greenhouse environment, for example, ammonia generated by the electrolyzer 114 may be used for fertilization of greenhouse plants, while hydrogen produced may be used to power nearby facilities.

For certain applications, the system may be placed atop a tall building or other structure to thereby provide increased access to humid air and direct sunlight for maximum power delivered by solar generation devices (e.g., solar panels). In other embodiments, the system may be placed near a flowing dam, and hydroelectric power generated by the dam may be used to power the system. In such an environment, the water generation device 102 may capture water from water-saturated air near the dam. Alternatively, water collected from the dam may be used to supplement the water captured by the metal-organic framework device.

In various embodiments, ambient air input into the water generation device 102 may be recirculated many times through an airtight system and containment enclosure to thereby extract a maximum amount of water from a give quantity of air. Additionally, after the air has been recirculated, it may be pumped into a separate modular oxygen compression and dryer system. In such an embodiment, the air input to the oxygen compression and dryer system may be mostly dry and may minimize the need to run a separate drying sequence.

The above systems, devices, methods, and processes may be realized in hardware, software, or any combination of these suitable for the control, data acquisition, and data processing described herein. This includes realization in one or more microprocessors, microcontrollers, embedded microcontrollers, programmable digital signal processors or other programmable devices or processing circuitry, along with internal and/or external memory. This may also, or instead, include one or more application specific integrated circuits, programmable gate arrays, programmable array logic components, or any other device or devices that may be configured to process electronic signals. It will further be appreciated that a realization of the processes or devices described above may include computer-executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. At the same time, processing may be distributed across devices such as the various systems described above, or all of the functionality may be integrated into a dedicated, standalone device. All such permutations and combinations are intended to fall within the scope of the present disclosure.

Embodiments disclosed herein may include computer program products including computer-executable code or computer-usable code that, when executing on one or more computing devices, performs any and/or all of the operations of the control systems described above. The code may be stored in a non-transitory fashion in a computer memory, which may be a memory from which the program executes (such as random access memory associated with a processor), or a storage device such as a disk drive, flash memory, or any other optical, electromagnetic, magnetic, infrared or other device or combination of devices. In another aspect, any of the control systems described above may be embodied in any suitable transmission or propagation medium carrying computer-executable code and/or any inputs or outputs from same.

The method operations of the implementations described herein are intended to include any suitable method of causing such method operations to be performed, consistent with the patentability of the following claims, unless a different meaning is expressly provided or otherwise clear from the context. So, for example performing the operation of X may include any suitable method for causing another party such as a remote user, a remote processing resource (e.g., a server or cloud computer) or a machine, to perform the operation of X. Similarly, performing operations X, Y and Z may include any method of directing or controlling any combination of such other individuals or resources to perform operations X, Y and Z to obtain the benefit of such operations. Thus, method operations of the implementations described herein are intended to include any suitable method of causing one or more other parties or entities to perform the operations, consistent with the patentability of the following claims, unless a different meaning is expressly provided or otherwise clear from the context. Such parties or entities need not be under the direction or control of any other party or entity, and need not be located within a particular jurisdiction.

It will be appreciated that the methods and systems described above are set forth by way of example and not of limitation. Numerous variations, additions, omissions, and other modifications will be apparent to one of ordinary skill in the art. In addition, the order or presentation of method operations in the description and drawings above is not intended to require this order of performing the recited operations unless a particular order is expressly required or otherwise clear from the context. Thus, while particular embodiments have been shown and described, it will be apparent to those skilled in the art that various changes and modifications in form and details may be made therein without departing from the scope of the disclosure.

What is claimed is:

1. A system configured to generate oxygen and at least one of hydrogen or ammonia, comprising:
a water generation device that is configured to collect liquid water from ambient air that contains moisture; and
a water electrolyzer that is configured to receive the liquid water collected by the water generation device, to receive electricity from an electrical source, and to perform an electrolysis process to thereby generate the oxygen and the at least one of hydrogen or ammonia from the received liquid water and electricity.

2. The system of claim 1, wherein the water generation device includes a metal-organic framework that is configured to adsorb water from relatively cooler ambient air and to receive heat from a heat source to desorb water into relatively hot ambient air to form humid air.

3. The system of claim 2, further comprising a condenser configured to cool and condense the humid air received from the water generation device and to thereby generate the liquid water.

4. The system of claim 3, wherein:
the heat source comprises the water electrolyzer;
heat generated by the electrolysis process is transferred to the water generation device through a conduit; and
the water electrolyzer comprises a polymer exchange membrane electrolyzer.

5. The system of claim 2, further comprising:
an impedance sensor configured to measure an impedance of the liquid water collected by the water generation device; and
a processor-implemented controller configured to receive the measured impedance and to determine a state of health or degradation of the metal-organic framework, based on the measured impedance.

6. The system of claim 2, further comprising:
a water production sensor configured to measure an amount of the liquid water collected by the water generation device;
a temperature sensor configured to measure a temperature of the ambient air;
a humidity sensor configured to measure a humidity of the ambient air; and and
a processor-implemented controller configured:
to determine a predicted amount of collected water based on the measured temperature and humidity of the ambient air; and
to determine a state of health or degradation of the metal-organic framework, based on a comparison of the measured amount of collected water and the predicted amount of collected water.

7. The system of claim 2, wherein the heat source comprises a solar heat generation device that is configured to generate heat based on received sunlight and to provide the generated heat to the water generation device.

8. The system of claim 1, wherein the electrical source comprises a solar energy conversion device, and further comprising an external water condenser comprising an electrically powered cooling element that is configured to receive electricity generated by the solar energy conversion device.

9. The system of claim 1, further comprising a water polisher that is configured to filter and clean the liquid water collected by the water generation device before the liquid water is provided to water electrolyzer.

10. The system of claim 1, wherein the water generation device comprises a condenser device.

11. The system of claim 10, wherein the condenser device contains a cooler configured to receive the ambient air and to cool and condense the ambient air to thereby generate the liquid water.

12. The system of claim 11, wherein the cooler is configured to receive cooled hydrogen gas generated by the water electrolyzer and to use the cooled hydrogen gas to remove heat from the ambient air to thereby cool the ambient air.

13. The system of claim 12, wherein the cooler comprises:
an enclosure that is configured to allow the ambient air to flow through the enclosure; and
a tube or manifold positioned within the enclosure and configured to allow the cooled hydrogen gas to flow through the tube or manifold to cool the ambient air.

14. The system of claim 12, further comprising a de-pressurizer device that is configured to receive pressurized hydrogen gas generated by the water electrolyzer and to reduce the pressure of the pressurized hydrogen gas to thereby generate the cooled hydrogen gas.

15. The system of claim 1, wherein the water generation device comprises a rain water collector.

16. A method of generating oxygen and at least one of hydrogen or ammonia, comprising:
receiving ambient air containing moisture;
collecting liquid water from the ambient air;
receiving, by a water electrolyzer, the collected liquid water and electricity from an electrical source; and
performing an electrolysis process, by the water electrolyzer, to thereby generate the oxygen and the at least one of hydrogen or ammonia from the received liquid water and electricity.

17. The method of claim 16, wherein collecting the liquid water comprises using a metal-organic framework and a condenser device.

18. The method of claim 16, wherein collecting the liquid water comprises cooling and condensing the ambient air to generate the liquid water.

19. The method of claim 18, wherein the ambient air is cooled using the hydrogen generated by the water electrolyzer.

20. The method of claim 16, wherein collecting the liquid water from the ambient air comprises collecting rain water from the ambient air.
